(19) United States
(12) Patent Application Publication
(10) Pub. No.: US 2007/0245395 A1
(43) Pub. Date: Oct. 18, 2007

(54) Video reproducing apparatus

(76) Inventor: Yasuo Masuda, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/783,698

(22) Filed: Apr. 11, 2007

(30) Foreign Application Priority Data
Apr. 13, 2006 (JP) 2006-111225

(51) Int. Cl. H04N 7/173

(52) U.S. Cl. 725/131; 725/100

(57) ABSTRACT

A conventional digital video reproducing apparatus outputs a descrambling request to a descrambling processing unit also on a packet which is not needed to be descrambled. When types of inputted packets exceeds the maximum number of types of packet that the descrambling processing unit can simultaneously descramble, it is impossible for the conventional apparatus to descramble a packet to be descrambled, whereby an audio and a video are not reproduced. In contrast to this, A PMT processing section 6 deletes data on a packet of a type, that a video decoder 4 and an audio decoder 5 cannot decode, from a program map table PMT acquired from a TS decoder 3. Based on processed PMT information Ipmt processed by the PMT processing section 6, a descrambling card 2 descrambles only packets having data formats that the video decoder 4 and the audio decoder 5 can reproduce.

### BACKGROUND OF THE INVENTION

1. Field of the Invention

The present invention relates to a video reproducing apparatus, and more specifically to a video reproducing apparatus provided with an external descrambling module.

2. Description of the Background Art

Conventionally, as for a video reproducing apparatus provided with an external descrambling module, an interface between the external module and the video reproducing apparatus is described in a specification of an open cable, which is a North American Standard specification, (for example, refer to “ANSI SCTE282003DVS295 (American National Standard Institute (ANSI)”).

FIG. 7 is a block diagram illustrating a configuration of a digital broadcasting receiver as an example of a conventional video reproducing apparatus.

A video reproducing apparatus 91 shown in FIG. 7 is provided with a tuner 81, a descrambling card 82, a transport stream decoder (hereinafter, referred to as “TS decoder”) 83, a video decoder 84, and an audio decoder 85.

Upon receiving the digital broadcasting signal, the tuner 81 generates a transport stream by demodulating the received digital broadcasting signal, and outputs the generated transport stream to a descrambling card 82.

The descrambling card 82 is an external module coupled to the video reproducing apparatus 91, and descrambles the transport stream outputted from the tuner 81 based on information included in a program map table (hereinafter, referred to as “PMT”) extracted by the TS decoder 83. The video reproducing apparatus 91 outputs the transport stream descrambled by the descrambling card 82 to the TS decoder 83.

The TS decoder 83 restores a video packet and an audio packet from the descrambled transport stream, and outputs the restored video packet and the restored audio packet to the video decoder 84 and the audio decoder 85, respectively.

The video decoder 84 and the audio decoder 85 restore video data and audio data, respectively, by decoding the packets outputted from the TS decoder 83. The restored video data and the audio data are further converted into a video signal and an audio signal by a following circuit, respectively. The converted video signal and the audio signal are outputted from an output device, such as a monitor, a speaker, or the like, and a received program is reproduced.

FIG. 8A illustrates an example of the program map table used in the video reproducing apparatus shown in FIG. 7.

Information in which a data attribute (data format) contained in a TS packet and an identification number for identifying the data attribute are associated with each other is defined in the program map table. For example, in an example shown in FIG. 8A, identification numbers 11 through 16 are assigned to six types of data attributes, namely, MPEG1 video, MPEG2 video, MPEGaudio (main-audio), MPEGaudio (sub-audio), AC3 (main-audio), and AC3 (sub-audio)), respectively.

FIG. 8B illustrates a configuration example of the transport stream.

The transport stream is composed of a plurality of TS packets each including a packet header and a payload. An identifier for indicating the data attribute included in the payload is set in each of the packet headers of the TS packet. A correspondence relation between the identifier and the data attribute included in the TS packet is the same as that defined in the PMT shown in FIG. 8A.

FIG. 9 is a flow chart illustrating a descrambling process executed in the video reproducing apparatus shown in FIG. 7.

First, when the scrambled video data is inputted into the descrambling card 82 from the tuner 81 (Step S901), the descrambling card 82 acquires PMT from the TS decoder 83 (Step S902).

Next, the descrambling card 82 executes a descrambling process for a packet containing an identification number defined in the acquired PMT in the packet header thereof (Step S903). The descrambling card 82 outputs the transport stream containing the descrambled packet to the TS decoder 83.

The video packet and the audio packet restored by the TS decoder 83 are reproduced by the video decoder 84 and the audio decoder 85, respectively (Step S904).

However, as constraints of throughput, a certain descrambling card has a limit to the number of types of packets which can be simultaneously descrambled. In this case, the descrambling card simultaneously descrambles packets within the limit and output the descrambled packets to the TS decoder, while outputting packets having types which are out of the limit to the TS decoder without descrambling them.

For example, it is assumed a case where the descrambling card 82 shown in FIG. 7 can simultaneously descramble three types of packets. In this case, upon receiving the transport stream shown in FIG. 8B (namely, the transport stream containing six types of packets), the descrambling card 82 simultaneously descrambles only three types of packets, for example, MPEG2 video, MPEG1 video, and MPEG audio (main). In this case, MPEG audio (sub-audio), AC3 (main-audio), and AC3 (sub-audio) packets are transmitted to the TS decoder 83 while they are scrambled.

Another document relevant to the above-mentioned technology includes, for example, “CableCARD (TM) Interface 2.0 Specification (CableLabs, U.S., Nov. 17, 2005, OC-SP-CCIF2.0-I03-051117, pp. 104-106).

As described above, the limit to the types of packet which can be simultaneously descrambled is provided with the descrambling card, as constraints of capability. In the conventional video reproducing apparatus that utilizes such a descrambling card, there are following problems.

First, there may be a case where the transport stream contains both of a packet that the video decoder or the audio decoder included in the video reproducing apparatus can reproduce and a packet that they cannot reproduce. The conventional video reproducing apparatus instructs the descrambling card to descramble the scrambled transport stream without relation to the type of packet that the video decoder and the audio decoder can reproduce. As a result, when the capability of the descrambling card is limited, the descrambling card descrambles packets which cannot be reproduced in the video decoder nor the audio decoder, thereby narrowing room for descrambling the required packets.

Second, there may be a case where a program that a viewer desires to watch and listen to is composed of video data and audio data in a predetermined data format. The conventional video reproducing apparatus instructs the descrambling card to descramble the code thereof without whether a packet composes the desired program. As a result, the capability of the descrambling card is limited, the descrambling card descrambles a packet other than the packets that compose the desired program, and thus there is a possibility that the packets that compose the desired program may not be descrambled.

In either case described above, since the conventional video reproducing apparatus instructs the descrambling card to descramble the packet which does not need to be descrambled, if the descrambling card receives the transport stream containing a plurality of types of packets exceeding the limit of the card, resources of the descrambling card for descrambling the required packets run short, and thus, there has been a problem that a video and an audio desired by the viewer could not be reproduced.

### SUMMARY OF THE INVENTION

Therefore, it is an object of the present invention to provide a video reproducing apparatus which can reproduce a video and an audio desired by a viewer, even when the number of types of packet that a descrambling card can simultaneously descramble is limited.

The present invention relates to a video reproducing apparatus for reproducing video data contained in an input signal in which a plurality of packets are multiplexed, which is coupled to a descrambling processing unit which descrambles a scrambled first bit stream in accordance with an externally inputted instruction and outputs a second bit stream which is generated by descrambling at least a part of the first bit stream has been descrambled. The video reproducing apparatus is provided with a tuner section for receiving the input signal to convert the received input signal into the first bit stream and outputting the first bit stream to the descrambling processing unit, a data input/output section for receiving the second bit stream outputted from the descrambling processing unit and outputting a packet contained in the second bit stream, a video reproduction section for reproducing the video data contained in the packet outputted from the data input/output section, and a descrambling instruction section for informing the descrambling processing unit of a data format of a packet to be descrambled among the packets contained in the first bit stream.

According to the present invention, since the descrambling card preferentially descrambles the packet instructed from the descrambling instruction section, it is possible to achieve the video reproducing apparatus, which allows the viewer to watch and listen to the video and the audio that the viewer desires even when the descrambling card has a limit to the number of types of packet which can be simultaneously descrambled.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a schematic configuration of a video reproducing apparatus in accordance with a first embodiment of the present invention;

FIG. 2 is a flow chart illustrating an example of a descrambling process executed in the video reproducing apparatus shown in FIG. 1;

FIG. 3A is a view illustrating an example of PMT processed by a PMT processing section shown in FIG. 1;

FIG. 3B is a view illustrating an example of a transport stream received by a descrambling card;

FIG. 4 is a block diagram illustrating a schematic configuration of a video reproducing apparatus in accordance with a second embodiment of the present invention;

FIG. 5 is a flow chart illustrating an example of a descrambling process executed in the video reproducing apparatus shown in FIG. 4;

FIG. 6A is a view illustrating an example of PMT processed by a PMT processing section shown in FIG. 4;

FIG. 6B is a view illustrating an example of a transport stream received by a descrambling card;

FIG. 7 is a block diagram illustrating a configuration of a digital broadcasting receiver as an example of a conventional video reproducing apparatus;

FIG. 8A is a view illustrating an example of a program map table used in the video reproducing apparatus shown in FIG. 7;

FIG. 8B is a view illustrating a configuration example of a transport stream; and

FIG. 9 is a flow chart illustrating a descrambling process executed in the video reproducing apparatus shown in FIG. 7.

### DESCRIPTION OF THE PREFERRED EMBODIMENTS

Hereinafter, a video reproducing apparatus in accordance with each embodiment of the present invention will be described in detail with reference to the drawings. As an example, the video reproducing apparatus in accordance with following each embodiment is achieved as a digital broadcasting receiver.

### First Embodiment

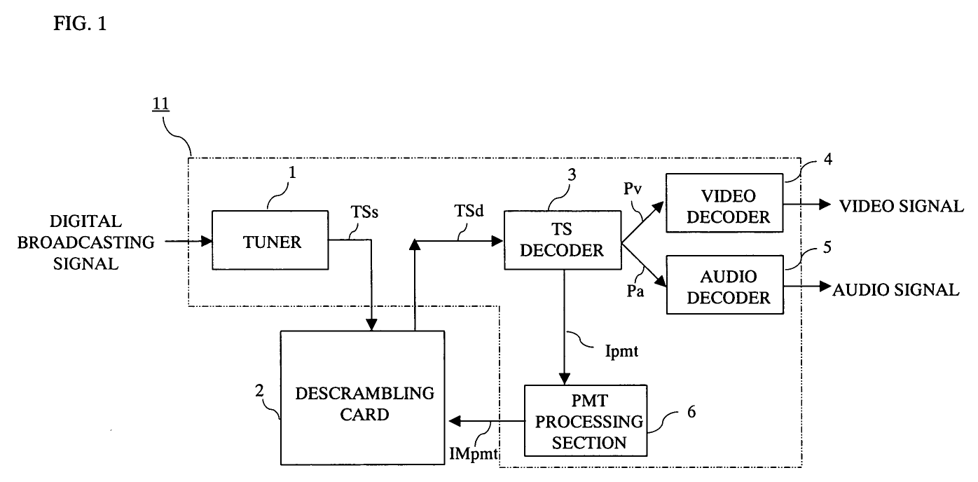

FIG. 1 is a block diagram illustrating a schematic configuration of a video reproducing apparatus in accordance with a first embodiment of the present invention.

A video reproducing apparatus 11 shown in FIG. 1 includes a tuner 1, a transport stream decoder (hereinafter, referred to as “TS decoder”) 3, a video decoder 4, an audio decoder 5, and a program map table processing section (hereinafter, referred to as “PMT processing section”) 6. The video reproducing apparatus 11 is provided with a descrambling card 2 which functions as an external descrambling processing unit.

The tuner 1 receives a digital broadcasting signal, as an input signal, from an antenna or a cable, and performs a demodulation processing, an error correction processing, or the like to the received digital broadcasting signal. In addition, the tuner 1 generates a transport stream TSs from the received digital broadcasting signal, and outputs the generated transport stream TSs to the descrambling card 2. The transport stream is a bit stream composed of a plurality of packets containing various kinds of data used for a digital broadcasting.

The descrambling card 2 is an external module, which is attached to the video reproducing apparatus 11, as the descrambling processing unit. The descrambling card 2 descrambles the transport stream TSs according to an external instruction (instruction from the PMT processing section 6 described later), and generates a descrambled transport stream TSd. The descrambling card 2 outputs the generated transport stream TSd to the TS decoder 3.

The TS decoder 3 restores a video packet Pv and an audio packet Pa from the descrambled transport stream TSd, and outputs the video packet Pv and the audio packet Pa to the video decoder 4 and the audio decoder 5, respectively. In addition, the TS decoder 3 extracts a program map table (hereinafter, referred to as “PMT”), in which a data attribute contained in a payload of the TS packet and a unique identification number are associated with each other, from the scrambled transport stream TSs. The TS decoder 3 in the present embodiment corresponds to a data input/output section for receiving the transport stream TSd outputted from the descrambling card 2 and outputting the packet contained in the transport stream TSd.

The video decoder 4 restores the video data by decoding the video packet Pv outputted from the TS decoder 3, and outputs the restored video data to a following circuit or the like. The video data is converted into a video signal by the following circuit or the like and then is outputted from an output device, such as a monitor, as a video image.

Similarly, the audio decoder 5 restores the audio data by decoding the audio packet Pa outputted from the TS decoder 3, and outputs the restored audio data to a following circuit or the like. The audio data is converted into an audio signal by the following circuit or the like and then is outputted from an output device, such as a loudspeaker, as an audio sound.

The PMT processing section 6 acquires PMT information Ipmt which is extracted by the TS decoder 3, and after processing the acquired PMT information Ipmt, it outputs the processed PMT information IMpmt to the descrambling card 2. More specifically, the PMT processing section 6 previously stores the identification number of the data attribute (data compression format) that the video decoder 4 and the audio decoder 5 can decode, and extracts only data specified by the previously-stored identification number among the pieces of acquired PMT information Ipmt. The PMT processing section 6 generates the processed PMT information IMpmt containing only the extracted data, and outputs the processed PMT information IMpmt to the descrambling card 2. The PMT processing section 6 in accordance with the present embodiment corresponds to a descrambling instruction section for instructing the data format of the packet to be descrambled among the packets contained in the transport stream TSs to the descrambling card 2.

Note that a method for previously storing into the PMT processing section 6 the data attribute that the video decoder 4 and the audio decoder 5 can decode is not limited in particular. As one example, it may be possible to store in advance the data attribute in the PMT processing section 6 during manufacturing the video reproducing apparatus 11 based on a specification of the video decoder 4 and the audio decoder 5. Alternatively, as another example, a storage medium, such as a non-volatile memory or the like which the PMT processing section 6 can refer to and rewrite is prepared, and the data attribute that the video decoder 4 and the audio decoder 5 can decode may be set by externally inputting a signal or the like.

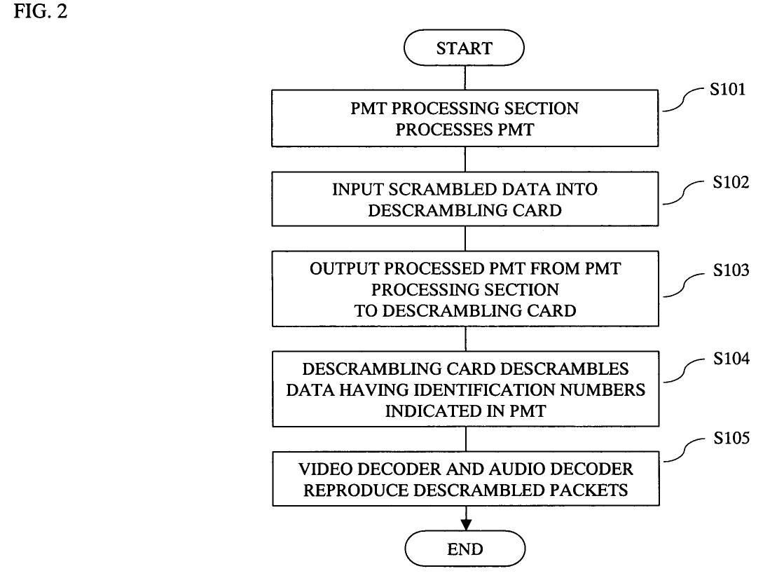

FIG. 2 is a flow chart illustrating an example of a descrambling process executed in the video reproducing apparatus 11 shown in FIG. 1.

First, the PMT processing section 6 processes PMT (Step S101). More specifically, the PMT processing section 6 acquires the PMT information Ipmt which is extracted by the TS decoder 3 from the transport stream TSs containing scrambled packets, and extracts only information on a compressed format that the video decoder 4 and the audio decoder 5 can reproduce, from the acquired PMT information Ipmt by deleting information on the data attribute that the video decoder 4 and the audio decoder 5 cannot reproduce based on the identification number stored in advance.

Next, when the scrambled transport stream TSs is imputed to descrambling card 2 from the tuner 1 (Step S102), the descrambling card 2 acquires the processed PMT information IMpmt from the PMT processing section 6 (Step S103).

Next, the descrambling card 2 executes the descrambling process for the packet containing the identification number defined in the acquired processed PMT information IMpmt in the packet header thereof (Step S104). The descrambling card 2 outputs the transport stream TSd containing the descrambled packet to the TS decoder 3.

The video packet Pv and the audio packet Pa restored by the TS decoder 3 are reproduced by the video decoder 4 and the audio decoder 5, respectively (Step S105).

In FIG. 2, Step S101 at which the PMT processing section 6 processes PMT is executed each time the PMT, which is contained in the transport stream and is to be extracted by the TS decoder 3, changes.

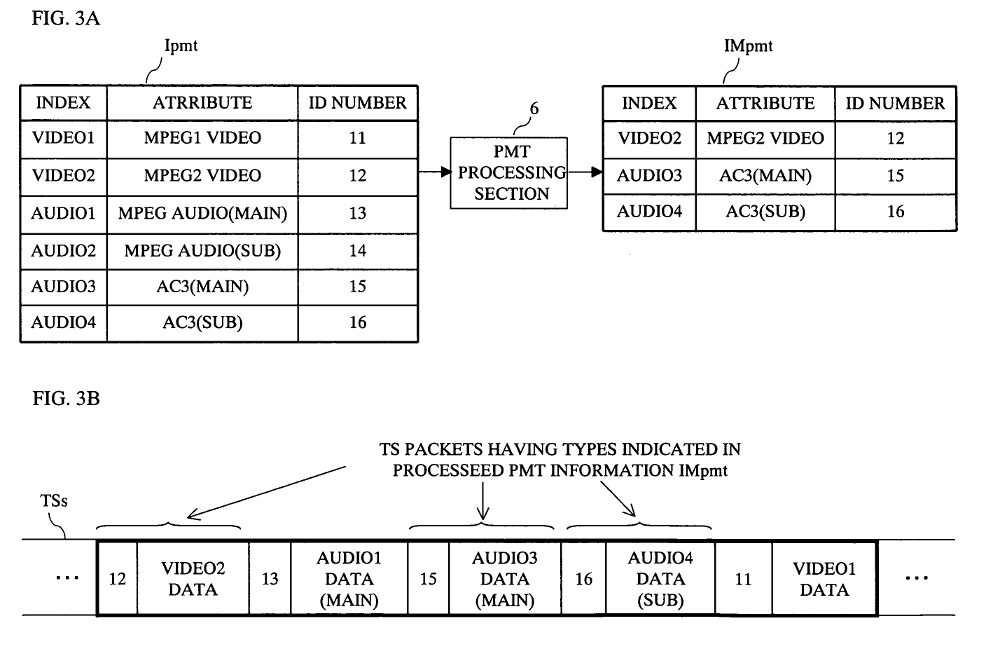

Hereinafter, an example of a process of the PMT processing section 6 will be further described with reference to FIG. 3A and FIG. 3B.

FIG. 3A is a view illustrating an example of PMT processed by the PMT processing section 6 shown in FIG. 1.

As described above, the PMT processing section 6 previously stores a video compression format that the video decoder 4 can reproduce and an audio compression format that the audio decoder 5 can reproduce. Hereinafter, for the purpose of simplification, it is assumed a case where the video decoder 4 shown in FIG. 1 can reproduce MPEG2 video and the audio decoder 5 shown in FIG. 1 can reproduce AC3 audio.

The PMT processing section 6 deletes information on MPEG1 video that the video decoder 4 cannot reproduce and information on MPEG audio that the audio decoder 5 cannot reproduce among the pieces of PMT information acquired from the TS decoder 3. In other words, the PMT processing section 6 extracts the information on MPEG2 video that the video decoder 4 can reproduce and the information on AC3 that the audio decoder 5 can reproduce among the pieces of PMT information Ipmt, and generates the processed PMT information IMpmt.

As shown in FIG. 3, three types of attributes, i.e., MPEG2 video, AC3 (main-audio), and AC3 (sub-audio), which are associated with identification numbers 12, 15, and 16, respectively, are defined in the processed PMT information IMpmt as shown in FIG. 3A. The processed PMT information IMpmt indicates that the descrambling process is to be executed by the descrambling card 2 with respect to packets having these three types of attributes.

FIG. 3B is a view illustrating an example of the transport stream received by the descrambling card.

Five types of TS packets, which have identification numbers 11 through 13, 15, and 16 in the packet header, respectively, are contained in the transport stream TSs shown in FIG. 3B. As shown in FIG. 3A, the identification number 11 (Video 1 [MPEG1 video]) and the identification number 13 (Audio1 [MPEG Audio (main)]) are not defined in the processed PMT information IMpmt that the descrambling card 2 has received from the PMT processing section 6.

As a result, although the descrambling card 2 descrambles the TS packets having the identification numbers 12, 15, and 16 among five types of TS packets contained in the transport stream TSs and then outputs the descrambled packets, it outputs scrambled packets having the identification numbers 11 or 13 as they are scrambled.

Here, it is further assumed a case where the descrambling card 2 has a capability of simultaneously descrambling three types of packets and a program desired by a viewer is composed of MPEG2video and AC3 audio.

The conventional video reproducing apparatus instructs the descrambling card to descramble the packet containing the data of, for example, MPEG2 video, MPEG1 video, and MPEG audio (main), regardless of the packet type that the video decoder and the audio decoder can reproduce. In this case, since the conventional video reproducing apparatus outputs the packet containing the data of MPEG audio (sub-audio), AC3 (main-audio), and AC3 (sub-audio) as they are scrambled, AC3 (main-audio) and AC3 (sub-audio) desired by the viewer are not reproduced. In other words, in the conventional video reproducing apparatus, there may be a case where resources of the descrambling card are not necessarily allocated for descrambling the packet that the video decoder and the audio decoder can reproduce.

In contrast to this, in the video reproducing apparatus 11 in accordance with the present embodiment, the PMT processing section 6 instructs the descrambling card 2 to descramble the packet that the video decoder 4 and the audio decoder 5 can reproduce. As a result, according to the video reproducing apparatus 11 of the present embodiment, it is possible to effectively utilize the resources of the descrambling card 2 for descrambling the required packet, thereby allowing the packets of MPEG2 video, AC3 (main-audio), and AC3 (sub-audio), which are playable for the apparatus, to be preferentially descrambled.

In the present embodiment, a case where the video compression format that the video decoder 4 can reproduce is MPEG2 video and the audio compression format that the audio decoder 5 can reproduce is AC3 format is described. If the video compression format that the video decoder 4 can reproduce is only MPEG1 video and the video decoder 4 cannot reproduce MPEG2 video, the PMT processing section 6 similarly creates the processed PMT information IMpmt containing only the information on MPEG1 video by deleting the information on MPEG2 video from the PMT information Ipmt. In addition, if the audio compression format that the audio decoder 5 can reproduce is only MPEG audio, the PMT processing section 6 may create the processed IMpmt containing only the information on MPEG audio by deleting the information on AC3 from the PMT information Ipmt.

### Second Embodiment

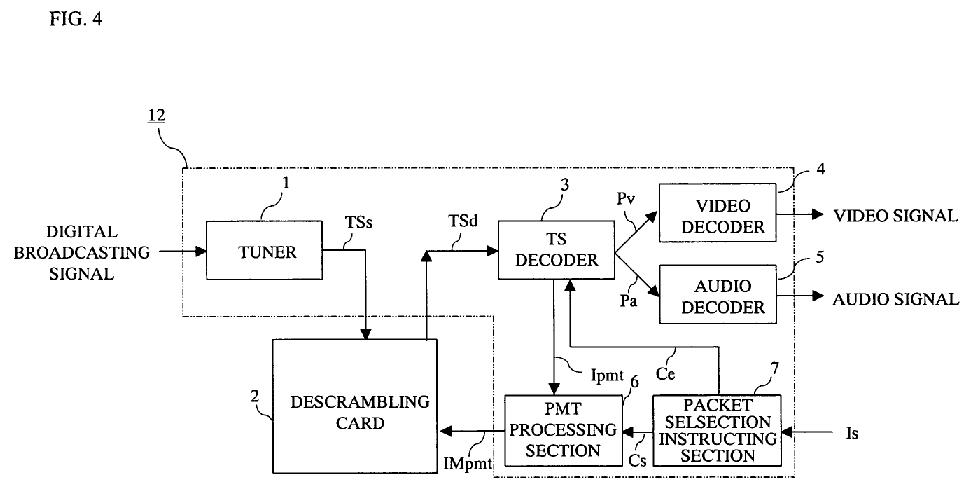

FIG. 4 is a block diagram illustrating a schematic configuration of a video reproducing apparatus in accordance with a second embodiment of the present invention.

Since a configuration of a video reproducing apparatus 12 of the second embodiment is similar to that of the first embodiment, differences between the first and second embodiments will be mainly described below.

The video reproducing apparatus 12 of the present embodiment is different from that of the first embodiment in that the apparatus further include a packet selection instructing section 7.

The packet selection instructing section 7 receives selection information Is including the video and audio compression formats of the program that the viewer desires to watch and listen to. Based on the received selection information Is, the packet selection instructing section 7 outputs to the PMT processing section 6 a command Cs for specifying a packet to be descrambled, and outputs to the TS decoder 3 a command Ce including the type of packet to be extracted from the descrambled transport stream TSd. The selection information Is may be supplied from a device outside the video reproducing apparatus 12, or may be supplied from any component in the video reproducing apparatus 12.

In accordance with the command Ce from the packet selection instructing section 7, the TS decoder 3 extracts the packets from the transport stream TSd received from the descrambling card 2, and outputs the extracted packets to the video decoder 4 or the audio decoder 5.

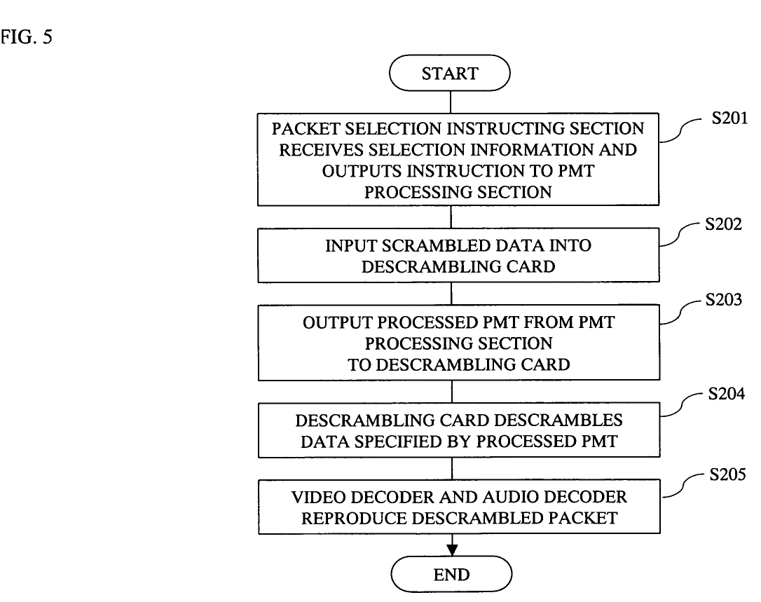

FIG. 5 is a flow chart illustrating an example of the descrambling process executed in the video reproducing apparatus shown in FIG. 4.

First, upon receiving the selection information Is, the packet selection instructing section 7 outputs the command Cs for specifying the packet to be descrambled to the PMT processing section 6 (Step S201).

Next, the PMT processing section 6 processes PMT based on the command Cs from the packet selection instructing section 7. More specifically, the PMT processing section 6 acquires the PMT information Ipmt which is extracted by the TS decoder 3 from the transport stream TSs containing scrambled packets, and extracts only information on the compression format specified by the packet selection instructing section 7 from the acquired PMT information Ipmt based on the identification number stored in advance.

Next, when the scrambled transport streamTSs is inputted into the descrambling card 2 by the tuner 1 (Step S202), the descrambling card 2 acquires the processed PMT information IMpmt from the PMT processing section 6 (Step S203).

Next, the descrambling card 2 executes the descrambling process for the packet containing the identification number defined in the acquired processed PMT information IMpmt in the packet header thereof (Step S204). The descrambling card 2 outputs the transport stream TSd containing the descrambled packet to the TS decoder 3.

The video packet Pv and the audio packet Pa outputted from the TS decoder 3 are reproduced by the video decoder 4 and the audio decoder 5, respectively (Step S205).

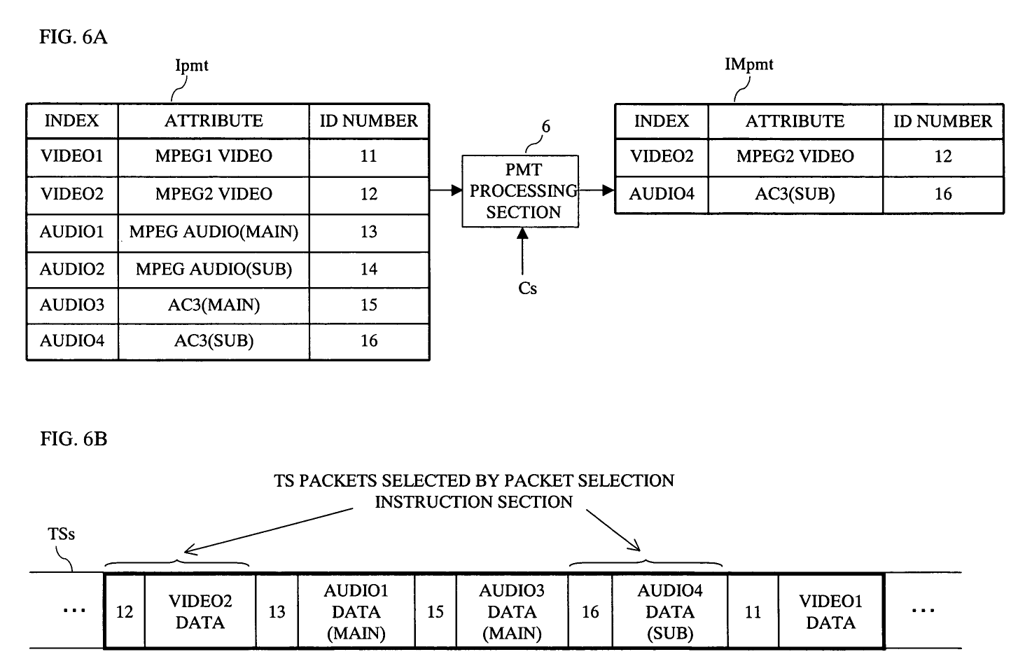

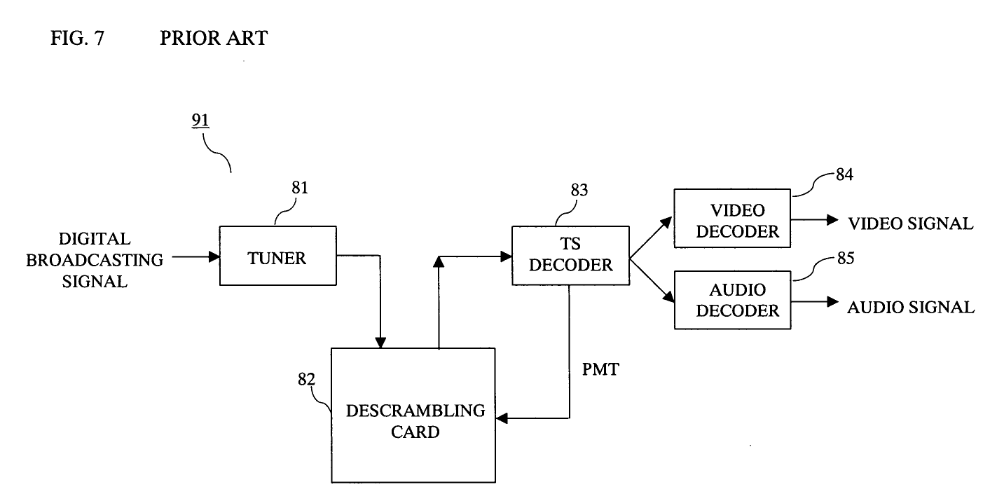

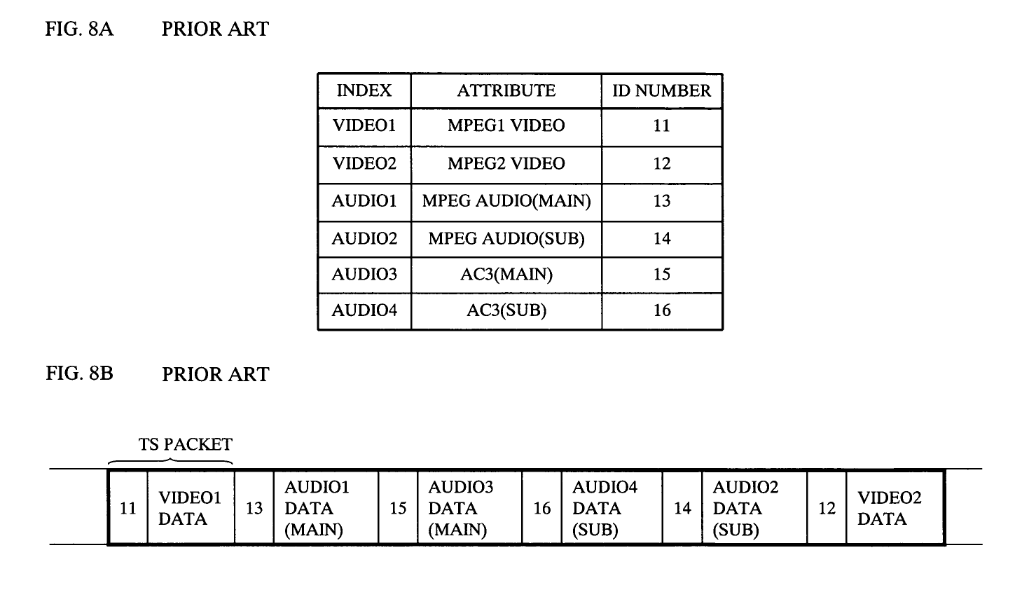

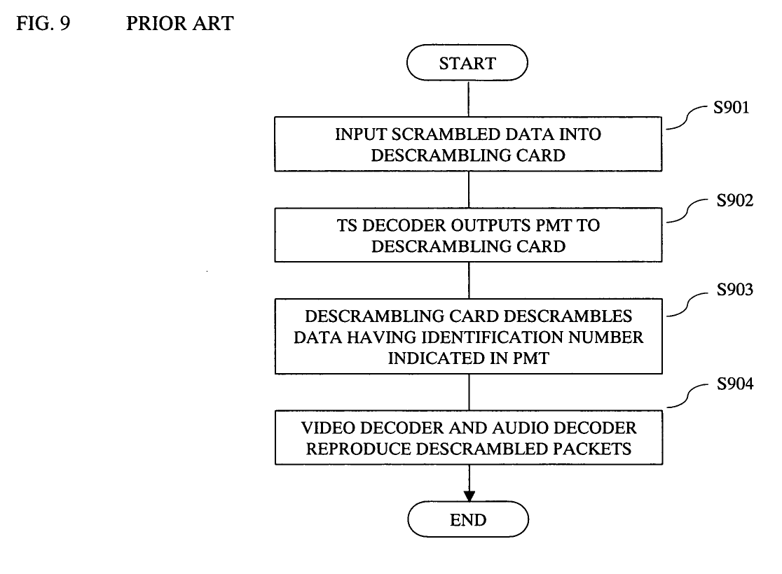

Hereinafter, an example of a process of the PMT processing section 6 will be further described with reference to FIG. 6A and FIG. 6B.

FIG. 6A is a view illustrating an example of PMT processed by the PMT processing section 6 shown in FIG. 4.

Hereinafter, for the purpose of simplification, it is assumed a case where the descrambling card 2 has a capability of simultaneously descrambling two types of packets and where a program desired by the viewer is composed of MPEG2 video and AC3 audio. Additionally, it is assumed a case where the program desired by the viewer is composed of data of MPEG2 video and AC3 (sub).

The packet selection instructing section 7 receives the selection information Is containing the video and audio compression formats of the program that the viewer desires to watch and listen to, and outputs to the PMT processing section 6 the command Cs for selecting the data compression formats (MPEG2 video and AC3 (sub)) indicated in the received selection information Is.

The PMT processing section 6 acquires the PMT information Ipmt from the TS decoder 3, and extracts the information on MPEG2 video and AC3 (sub), specified by the packet selection instructing section 7, from the acquired PMT information and generates the processed PMT information IMpmt.

As shown in FIG. 6A, two types of packets, i.e., MPEG2 video and AC3 (sub-audio), which are associated with identification numbers 12 and 16, respectively, are defined in the processed PMT information IMpmt. Namely, the processed PMT information IMpmt indicates that the descrambling process is executed by the descrambling card 2 with respect to two types of packets.

FIG. 6B is a view illustrating an example of the transport stream received by the descrambling card.

The transport stream TSs shown in FIG. 6B contains five types of TS packets each having respective the identification numbers 11 through 13, 15, and 16 in the packet header. As shown in FIG. 6A, only identification numbers 12 and 16 are specified in the processed PMT information IMpmt that the descrambling card 2 has received from the PMT processing section 6. As a result, although the descrambling card 2 descrambles the TS packets having the identification numbers 12 and 16 and outputs the descrambled packets, it outputs scrambled packets having the identification numbers 11 and 13 as they are.

Since the conventional video reproducing apparatus instructs the descrambling card to descramble the packet regardless of whether the packets compose the program desired by the viewer, there is a case where the scrambled packets containing, for example the data of AC3 (main-audio) and the data of AC3 (sub-audio) is outputted as they are. In this case, the conventional video reproducing apparatus cannot reproduce the audio data (AC3 (main-audio) and AC3 (sub-audio)) of the program that the viewer has desired. In other words, in the conventional video reproducing apparatus, the resources of the descrambling card is not necessarily allocated for descrambling the packet having the data attribute that the viewer desires to reproduce.

In contrast to this, in the video reproducing apparatus 12 in accordance with the present embodiment, the packet selection instructing section 7 receives the selection information Is for selecting MPEG2 video, AC3 (main-audio), and AC3 (sub-audio) desired by the viewer, and the PMT processing section 6 instructs the descrambling card 2 to descramble the packet informed by the packet selection instructing section 7. As a result, according to the video reproducing apparatus 12 of the present embodiment, it is possible to effectively utilize the resources of the descrambling card 2 for descrambling the required packet, thereby allowing the packets having the audio data (AC3 (main-audio) and AC3 (sub-audio)) of the program, which are desired by the viewer, to be preferentially descrambled.

In the present embodiment, a case where the program, that the viewer desires to watch and listen to, is composed of MPEG2 video and AC3. If the program, that the viewer desires to watch and listen to, is composed of MPEG1 video and MPEG audio, and if the video compression format that the video decoder 4 can reproduce is MPEG1 video and the audio compression format that the audio decoder 5 can reproduce is MPEG audio, the packet selection instructing section 7 may output the command Cs to the PMT processing section 6 to select the packets of MPEG1 video and MPEG audio (main). Also in this case, the viewer can watch and listen to MPEG1 video and MPEG audio (main).

The present invention can achieve the video reproducing apparatus allowing the viewer to watch and listen to the video and the audio of the desired program even in the case where the descrambling card has a limit to the number of types of packet which can be simultaneously descrambled. The present invention can be applied to an apparatus for receiving a digital video signal, for example, a digital broadcasting receiver, a set top box, a video cassette recorder, a DVD recorder, or the like.

While the invention has been described in detail, the foregoing description is in all aspects illustrative and not restrictive. It is understood that numerous other modifications and variations can be devised without departing from the scope of the invention.

What is claimed is:

1. A video reproducing apparatus for reproducing video data contained in an input signal in which a plurality of packets are multiplexed, which is coupled to a descrambling processing unit for descrambling a scrambled first bit stream in accordance with an externally inputted instruction and outputting a second bit stream which is generated by descrambling at least a part of the first bit stream, the video reproducing apparatus comprising:
a tuner section for receiving the input signal to convert the received input signal into the first bit stream and outputting the first bit stream to the descrambling processing unit;
a data input/output section for receiving the second bit stream outputted from the descrambling processing unit and outputting a packet contained in the second bit stream;
a video reproduction section for reproducing the video data contained in the packet outputted from the data input/output section; and
a descrambling instruction section for informing the descrambling processing unit of a data format of a packet to be descrambled among the packets contained in the first bit stream.

2. The video reproducing apparatus according to claim 1, wherein the descrambling instruction section informs the descrambling processing unit of a data format that the video reproduction section is operable to reproduce.

3. The video reproducing apparatus according to claim 1, wherein
the input signal further contains audio data,
the video reproducing apparatus further comprises an audio reproduction section for reproducing the audio data contained in the packet outputted from the data input/output section, and
the descrambling instruction section informs the descrambling processing unit of a data format that the audio reproduction section is operable to reproduce.

4. The video reproducing apparatus according to claim 2, wherein
the data input/output section extracts program map information in which the data format contained in the input signal is defined,
the descrambling instruction section acquires the program map information extracted by the data input/output section, generates processed program map information by extracting only information on the data format, that the video reproduction section is operable to reproduce, from the acquired program map information, and outputs the processed program map information to the descrambling processing unit.

5. The video reproducing apparatus according to claim 3, wherein
the data input/output section extracts the program map information in which the data format contained in the input signal is defined,
the descrambling instruction section acquires the program map information extracted by the data input/output section, generates the processed program map information by extracting only information on the data format, that the audio reproduction section is operable to reproduce, from the acquired program map information, and outputs the processed program map information to the descrambling processing unit.

6. The video reproducing apparatus according to claim 1, further comprising a packet selection instructing section for receiving selection information containing a desired data format and informing the descrambling instruction section of the data format contained in the selection information,
wherein the descrambling instruction section informs the descrambling processing unit of the data format specified by the packet selection instructing section.

7. The video reproducing apparatus according to claim 6, wherein
the selection information contains a data format of desired video data, and
the descrambling instruction section informs the descrambling processing unit of the data format of the video data specified by the packet selection instructing section.

8. The video reproducing apparatus according to claim 6, wherein
the input signal further contains the audio data,
the selection information further contains a data format of desired audio data,
the video reproducing apparatus further comprises an audio reproduction section for reproducing the audio data contained in the packet outputted from the data input/output section, and
the descrambling instruction section informs the descrambling processing unit of the data format of the audio data specified by the packet selection instructing section.

9. The video reproducing apparatus according to claim 7, wherein
the data input/output section extracts the program map information in which the data format contained in the input signal is defined,
the descrambling instruction section acquires the program map information extracted by the data input/output section, generates the processed program map information by extracting only information on the data format of the video data, specified by the packet selection instructing section, from the acquired program map information, and outputs the processed program map information to the descrambling processing unit.

10. The video reproducing apparatus according to claim 8, wherein
the data input/output section extracts the program map information in which the data format contained in the input signal is defined,
the descrambling instruction section acquires the program map information extracted by the data input/output section, generates the processed program map information by extracting only information on the data format of the audio data, specified by the packet selection instructing section, from the acquired program map information, and outputs the processed program map information to the descrambling processing unit.
